(19) United States
(12) Patent Application Publication
(10) Pub. No.: US 2011/0094899 A1
(43) Pub. Date: Apr. 28, 2011

(54) Container for Waste Electrical and Electronic Equipment

(75) Inventors: Christopher Patrick Johnson, Belper (GB); Vincent Eckerman, Northumberland (GB)

(73) Assignee: COVENTRY UNIVERSITY, Coventry (GB)

(21) Appl. No.: 12/865,167

(22) PCT Filed: Feb. 2, 2009
(86) PCT No.: PCT/GB2009/000290

§ 371 Date: Dec. 30, 2010

(30) Foreign Application Priority Data
Feb. 1, 2008 (GB) 0801820.2

(51) Int. Cl. B65D 81/26; B65F 1/14; B65D 1/34; B65D 6/16; B65D 25/04

(52) U.S. Cl. 206/204; 220/23.87; 206/557; 220/666; 220/500

(57) ABSTRACT

A container (1) for the storage and transport of waste electrical and/or electronic equipment has at least one tray (17) provided with an array (24) of upwardly projecting resilient locating portions. The tray receives relatively small waste equipment such as electric lamps, mobile telephones or the like in a number of different orientations in which the items will occupy spaces between the locating portions and will be gripped by the locating portions.

The present invention relates to a container for waste electrical and electronic equipment (“WEEE”).

There is a need to dispose of WEEE in a safe environmentally friendly manner. There is a European Community Directive on the disposal of WEEE, which covers a wide range of products ranging from large items such as televisions and computers to smaller items such as light bulbs and fluorescent tubes. Luminaires used in commerce, industry, public places and so forth have to be disposed of in accordance with the Directive. Whilst domestic luminaires are not covered by the Regulation, consumers are encouraged to dispose of them in a safe and environmentally friendly manner, and there are safety issues regards toxic materials. Whilst conventional incandescent light bulbs do not raise significant issues as regards toxic materials, fluorescent light tubes contain quantities of toxic materials such as mercury, cadmium and lead. Many low energy light bulbs that are being introduced in order to reduce energy consumption operate on the fluorescent principle and their disposal presents problems.

To prevent breakage of a fluorescent light and release of toxic material, there needs to be a system for packaging them for transport to a safe recycling site. There have been various proposals for achieving this involving packing the lights into a container tightly, so that they cannot move around, with the accompanying risk of breakage. This may be appropriate for large organisations with a large turnover in lights, but it causes problems for smaller organisations where it might take a considerable time for sufficient lights to be accumulated to fill the container. It also presents problems for councils and others who provide recycling points, as there is no guarantee that consumers will pack lights correctly into the container without breakages, or in such a manner that there is a low risk of breakages in subsequent transport of the container.

According to one aspect of the present invention there is a provided a container for the storage and transport of waste electrical and/or electronic equipment having therein at least one horizontally disposed tray provided with an array of upwardly projecting resilient locating portions, adapted to receive a plurality of waste electrical and/or electrical items in a plurality of different orientations in which the items will occupy spaces between the locating portions and will be gripped by the locating portions. The items could be, for example, old mobile telephones or the like, although in general it is intended that the array of projections will be capable of receiving waste electric lights of various types such as fluorescent tubes, light bulbs, spot lights and various forms of lamp.

By way of example, in one embodiment of the invention there may be provided a matrix of spaced locating portions arranged in rows and columns. Preferably the matrix is regular with evenly spaced rows and columns. Considering an elongate, cylindrical fluorescent tube, this could be disposed in a gap extending between adjacent rows, or a gap extending between adjacent columns, or a gap extending diagonally. A mobile telephone could be located in a similar manner. A light bulb could be positioned with its bulbous end in the space between four adjacent locating portions, and the enlarged end of a spot light can be located in the same mariner.

The array may be in accordance with a pattern or random. A pattern may be in the form of a matrix comprising two series of rows arranged at angle. One series of rows may be arranged perpendicularly to the other, so as to constitute columns. For the purpose of this discussion, the term “column” will be used to distinguish one series of rows from another, regardless of whether the angle between the two series is a right angle or another angle. The direction of a column or row need not be parallel to a main dimension of the container or the tray, which typically will be of rectangular form, but may be at an angle aligned for example with a diagonal. The spacing of portions along a row may be regular or may vary according to a pattern or randomly. The spacing of portions along a row may be the same for each row or may vary from row to row, either according to a pattern or randomly. The spacing of portions along a column may be regular or may vary according to a pattern or randomly. The spacing of portions along a column may be the same for each column or may vary from column to column, either according to a pattern or randomly. The spacing between portions along rows may be the same as or different from the spacing of portions along columns. The spacing between adjacent rows may be constant or may vary according to a pattern or randomly. The spacing between adjacent columns may be constant or may vary according to a pattern or randomly. The spacing between adjacent rows may be the same as or different from the spacing between adjacent columns.

In a typical arrangement, there may be at least about 100 projections arranged in a matrix, and there may for example be at least about 150, or at least about 200, or at least about 225 projections, or at least about 250, or at least about 300, or at least about 350, or at least about 400, or at least about 450, or at least about 500, or at least about 550, or at least about 600, or at least about 625, or at least about 650, or at least about 700, or at least about 750, or at least about 800, or at least about 850, or at least about 900, or at least about 950, or at least about 1000. In a matrix, the spacing between adjacent projections in a row or between adjacent projections in a column may be between about 1.0 mm and about 20 mm, or between about 15 mm and about 30 mm, or between about 20 mm and about 35 mm, or between about 25 mm and about 40 mm, or between about 30 mm and about 45 mm, or between about 35 mm and about 50 mm. These spacings may relate to the maximum available space between the peripheries of adjacent projections, or to the spacing between the centres of adjacent projections. The projections may have diameters, i.e. maximum transverse extents of any parts that will engage items, of up to about 5 mm, or up to about 10 mm, or up to about 15 mm, or up to about 20 mm; or up to about 25 mm,

The form of the locating portions may be constant across the array or may vary in accordance with a pattern or randomly. Variations in form may be in respect of the shape and/or dimensions of the locating portions.

Preferably at least some of the locating portions have a circular cross section. The circular cross section may be of constant diameter along the vertical extent of a locating portion, in which case the locating portion will be in the form of a cylinder. The circular cross section may vary in a regular manner along the vertical extent of a locating portion, in which case the locating portion will be in the form of a cone or a truncated cone. The variation may be such that the larger diameter part is adjacent the base of the locating portion, adjacent the tray surface, or adjacent the top of the locating portion, remote from the tray surface. The circular cross section may vary along the vertical extent of a locating portion in a non-regular manner, and may for example provide a base section having a first diameter, a central section with a smaller diameter than the base section, and a top section with a diameter which is greater than that of the central section, and may be the same as, greater than, or smaller than, the diameter of the base section.

Cross sections other than circular may be used, such as cross sections which are of a square or other polygonal form, with or without curved portions on at least some corners. The cross section may be of constant form, in terms of horizontal extent, along the vertical extent of a locating portion. The cross section may vary in a regular manner along the vertical extent of a locating portion, in which case the locating portion could for example be in the form of a pyramid. The variation may be such that the larger dimension part is adjacent the base of the locating portion, adjacent the tray surface, or adjacent the top of the locating portion, remote from the tray surface. The cross section may vary along the vertical extent of a locating portion in a non-regular manner, and may for example provide a base section having a first size in a horizontal plane, a central section with a smaller size in a horizontal plane than the base section, and a top section with a size in a horizontal plane which is greater than that of the central section, and may be the same as, greater than, or smaller than, the size of the base section.

The base of the tray is preferably also of resilient material, and may be of the same material as the locating portions. However, the tray and locating portions may be of different materials, and indeed the locating portions themselves may be of differing materials. All materials may be unitary materials or composites, and different regions of the tray and/or the locating portions may be of different materials.

Whilst the tray is adapted to receive lights, it can be used to receive other waste electrical or electronic goods, such as mobile telephones, personal digital assistants or the like.

In some embodiments, the material used may be plastics such as a foamed or expanded plastics material—for example expanded polystyrene; a natural or synthetic rubber; or a compressed fibrous material such as paper pulp. In one embodiment, there is a tray with locating portions which is formed from compressed paper pulp, and there is a supporting layer of another material such as a sheet of plastics or metal to support the tray. The supporting layer could be bonded to the tray, but in one embodiment is detachable from the tray, so that the tray itself can be disposed of after a period of use and replaced, whilst the supporting layer is re-used. References below to the tray encompass the tray alone, or the tray with a supporting layer.

The tray may be received by suitable locating portions within the container, preferably such that the tray can be slid in to the container in a horizontal direction. There could be grooves in opposing walls of the container, or longitudinal supports projecting from opposing walls, or spaced supporting portions arranged in a longitudinal direction, projecting from opposing walls. The locating portions preferably define slots or the like so that the tray is restrained from vertical movement in either direction. The container preferably has a door which can be opened to provide horizontal access to the tray. In such an arrangement, there may be a plurality of locating portions which are spaced vertically, so that a plurality of trays can be placed in the container, spaced vertically from each other. However, in an alternative arrangement, a tray adjacent the upper part of the container could be accessed from a lid at the top of the container.

In use, lights such as fluorescent tubes and/or bulbs, spotlights and so forth—whether conventional incandescent units or low energy units, will be arranged in suitable orientations in the tray, engaged resiliently by the locating portions so as to resist rolling around and other forms of dislodgement. Additionally or alternatively, other items such as mobile telephones can be placed in the tray. To provide additional security against breakage, there may be provided a resilient layer of material disposed above a tray. This material could be provided on the base of a tray above, or of a supporting layer for a tray above. In the case of a tray with no other tray above, the material could be provided on another portion of the container, above the tray. The resilient material can be of any of the resilient materials discussed above such as compressed paper pulp. The material could be in the form of a simple sheet, or alternatively the material could be provided with locating portions which can have any of the features discussed above. Thus a tray could be two sided, if necessary with a supporting layer between the two sides.

Whilst the container could be used exclusively for lights or other small waste electrical and electronic waste products, and intended to carry a full load of trays, in some preferred forms the container is intended to have only an upper portion occupied by one or more trays, there then being a lower region which can contain larger waste products such as televisions, radios and so forth. There may be a fixed or adjustable blanking plate or wall between that part of the container and the part containing the or each tray. Where there is such means defining a barrier with the region containing the tray, that may be provided with a disposable absorbent layer to catch any undesirable or toxic substances that may have come from the lights or other waste products in the tray, to prevent those substances contaminating other products in the container.

The container can preferably be stored and transported (empty of waste products) in a collapsed condition, and then erected for use. In one preferred embodiment, there is provided a collapsible container which comprises a top member defining a top of the container, a base member defining a base of the container, two side walls, a back wall and a front wall; wherein (a) in an erected state of the container the two side walls, the back wall and the front wall are connected to the top member and the base member to form a substantially rigid structure, with at least part of the front wall being movable pivotally between a closed position preventing access to the interior of the container, and an open position in which there is access to the interior of the container; and (b) in a collapsed state of the container the top member and the base member are in contact and interlocked together, so as to define a storage space in which are located the two side walls, the back wall and the front wall.

In one, embodiment of such a container, the top member and the base member are provided with latching portions that cooperate with portions on the front wall when the container is in the erected state, to hold the front wall in the closed position. In such an arrangement, when the container is in the collapsed state the latching portions on the top member and the base member may be used to latch the two shell portions together.

The tray for lights and other small items may be connected to at least the side walls when the container is in the erected state, and may also be contained in the space defined by the top and base members when the container is in the collapsed state. The arrangement is preferably such that in the erected state the tray is in the upper part of the container. In the erected state of the container, the top member may be pivotal upwardly to provide access to the tray and there may be a latch mechanism between the top member and a wall of the container to hold it in the closed position. There may be a barrier between the tray and the remainder of the container—for example provided with disposable layer of absorbent material for any toxic liquids—and this may also be contained in the space defined by the top and base members when the container is in the collapsed state.

The top member and the base member may be provided with cooperating protrusions and recesses, or like cooperating elements, in their upper and lower faces respectively, so that when a plurality of the containers are in the collapsed state they can be stacked on top of each other, with the cooperating elements resisting lateral slippage of the containers with respect to each other.

The lower part of the base member may be provided with open ended spaces to receive the times of a fork lift truck. The spaces may run from front to back, or from side to side, or preferably in both directions so as to maximise versatility in terms of accessing the containers with a fork lift truck.

In general in a number of embodiments the lower part of the container may have a cross section corresponding approximately to a conventional pallet, and may be adapted for transport by a fork lift truck. Additionally or alternatively, the container may have wheels (which expression includes rollers, casters and the like) to assist in movement and positioning, and the arrangement may be such that these can be locked when desired.

The interior base of the container, such as the interior of the base member in the embodiment discussed above, may be provided with a disposable absorbent layer to catch any undesirable or toxic substances that may have come from products within the container.

In general it is preferred if the material(s) of the tray and/or a supporting layer for the tray, and/or other portions of the container have been recycled and/or are recyclable.

The top and base members may in the form of cooperating shell portion portions which when located together form the space to contain the other panels. Alternatively, one of the top and base members could define a space to contain the panels and the other of the members could serve as a cover for the space. In one preferred embodiment the base member defines the space to hold the panels and the top member serves as a lid which is attached to the base member when the container is in the collapsed condition. In one arrangement, the base member defines an interior portion below where the panels will be located, to hold one or more trays when the container is in the collapsed condition.

The base member may be attached to the base of the front wall by a first hinge along a front part of the base member, to the base of one side wall by a second hinge along one side part of the base member, to the base of the rear wall by a third hinge along a rear part of the base member, and to the base of the other side wall by a fourth hinge along the other side part of the base member, with the vertical positions of the first, second, third and fourth hinges being displaced from each other upwardly, such that the front, rear and two side walls may be folded inwardly to overlie each other in the collapsed state of the container. In such a condition the top member can be connected to upwardly directed portions of the base member, overlying the folded walls of the container.

It will be appreciated that references to horizontal and vertical do not imply that directions or surface are strictly horizontal or vertical in a geometrical sense, and encompass generally upwards and generally level, for example. Similarly, references to front, rear and sides are relative only. Thus, for example, in defining the invention the front wall may be defined as the wall providing access to the interior of the container and other wall designations are relative to that. However, for aesthetic or other reasons in practice an alternative wall might be proposed as the “front” wall, in which case the wall with the opening might be the rear or a side wall relative to that designated front wall.

The invention may be viewed from many aspects. For example, preferred forms of the collapsible container may be of use even if no tray is provided and it is to contain only larger waste equipment. Thus, viewed from another aspect of the invention there is provided a collapsible container for the storage and transport of waste electrical and/or electronic equipment, comprises a top member defining a top of the container, a base member defining a base of the container, two side walls, a back wall and a front wall; wherein (a) in an erected state of the container the two side walls, the back wall and the front wall are connected to the top member and the base member to form a substantially rigid structure, with at least part of the front wall being movable pivotally between a closed position preventing access to the interior of the container, and an open position in which there is access to the interior of the container; and (b) in a collapsed state of the container the top member and the base member are in contact and interlocked together, so as to define a storage space in which are located the two side walls, the back wall and the front wall.

A further feature disclosed herein, which can be used alone or in combination with any of the features discussed above, is a plurality of battery compartments in a container, which can be accessed via appropriate apertures in a lid of the container. Thus, viewed from another aspect the invention provides a container for waste electrical batteries, the container being provided with a horizontal shelf and one or more vertical dividers which cooperate to define a plurality of battery compartments, there being a plurality of apertures in the lid which provide access to respective ones of the battery compartments, and the or each battery compartment below the shelf communicating with the corresponding aperture in the lid by means of a tube which passes through a battery compartment above the shelf and through the shelf. Preferably, the container is also provided with at least one horizontally disposed tray as described above, provided with an array of upwardly projecting resilient locating portions, adapted to receive a plurality of lights in a plurality of different orientations in which the lights will occupy spaces between the locating portions and will be gripped by the locating portions. Preferably there is a space below the battery compartments or the battery compartments and the tray, for larger items of electrical or electronic waste. With the exception of the inclusion of the battery compartments, which may be provided as separate, removable modules with side walls to retain the batteries, the container may be as described earlier.

Embodiments of the invention will now be described by way of example only, and with reference to the accompanying diagrammatic drawings, in which:

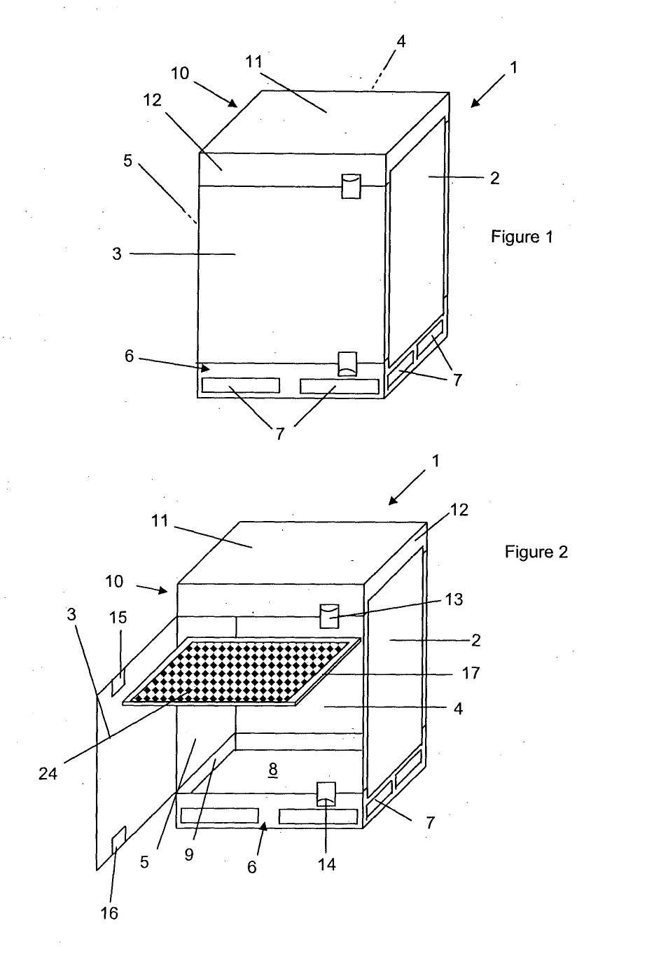

FIG. 1 is a perspective view of a first embodiment of a container in accordance with the invention, in its erected state;

FIG. 2 is a perspective of the container with a front panel open and a tray partially removed from the container;

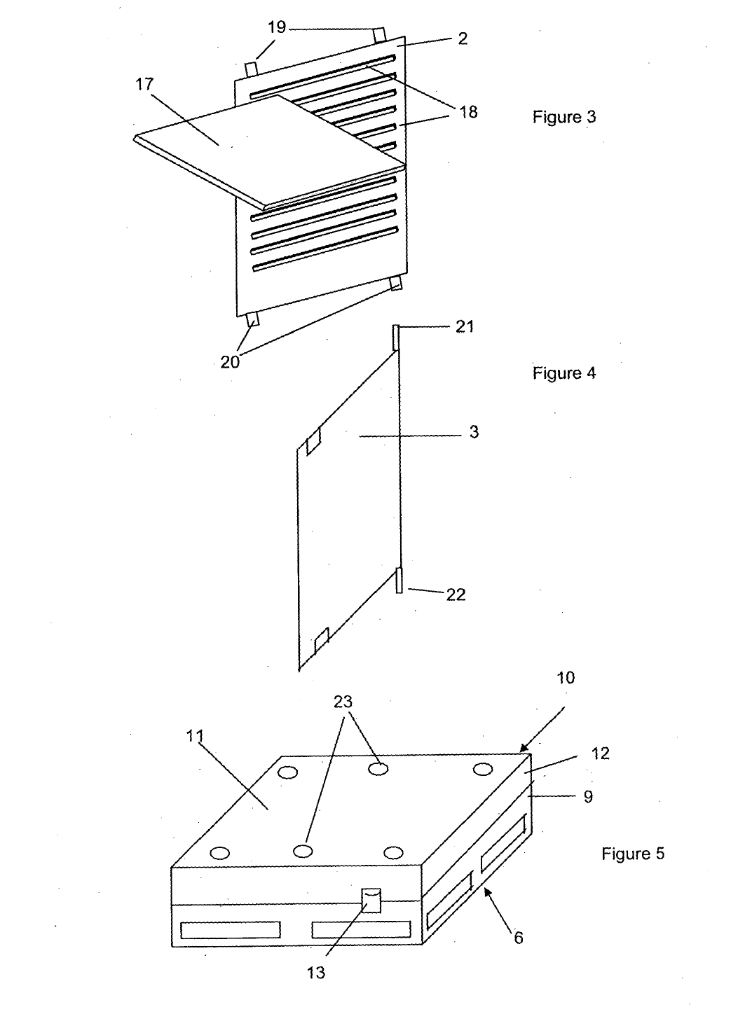

FIG. 3 is view showing how the tray is attached to one of the side panels;

FIG. 4 is a view of the front panel;

FIG. 5 is a view of the container in its collapsed state;

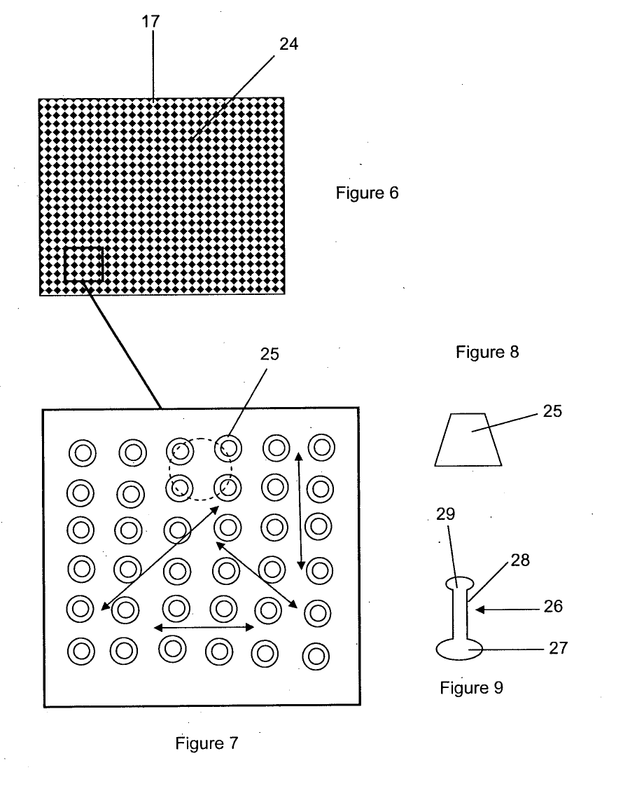

FIG. 6 is a diagrammatic view of the tray;

FIG. 7 is an enlarged view of part of FIG. 6, showing how products can be arranged in the tray;

FIG. 8 is a view of one embodiment of a projection on the tray;

FIG. 9 is a view of another embodiment of a projection on the tray;

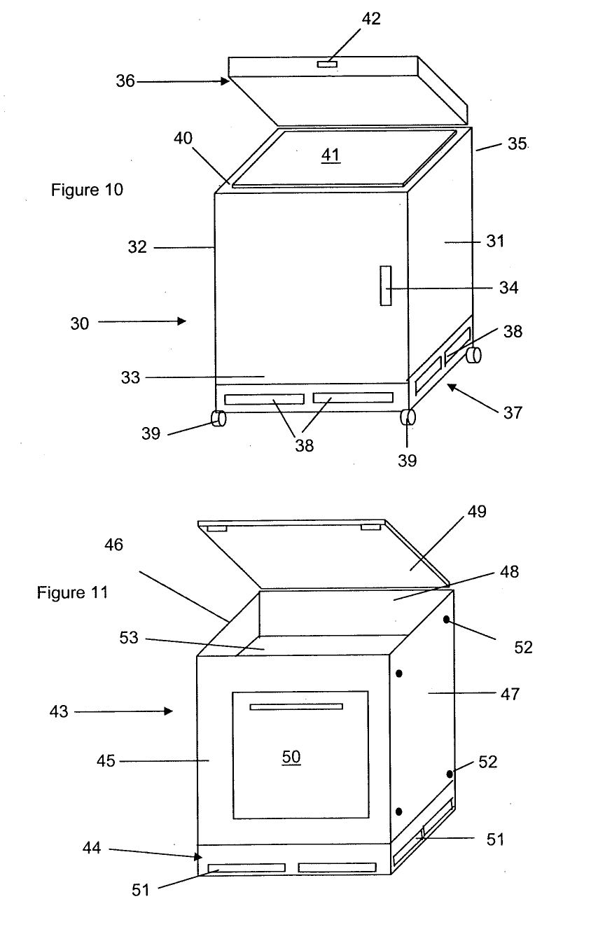

FIG. 10 is a front perspective view of a second embodiment of container in the erect state, with the top portion open and a tray in place;

FIG. 11 is a front perspective view of a third embodiment of container in the erect state;

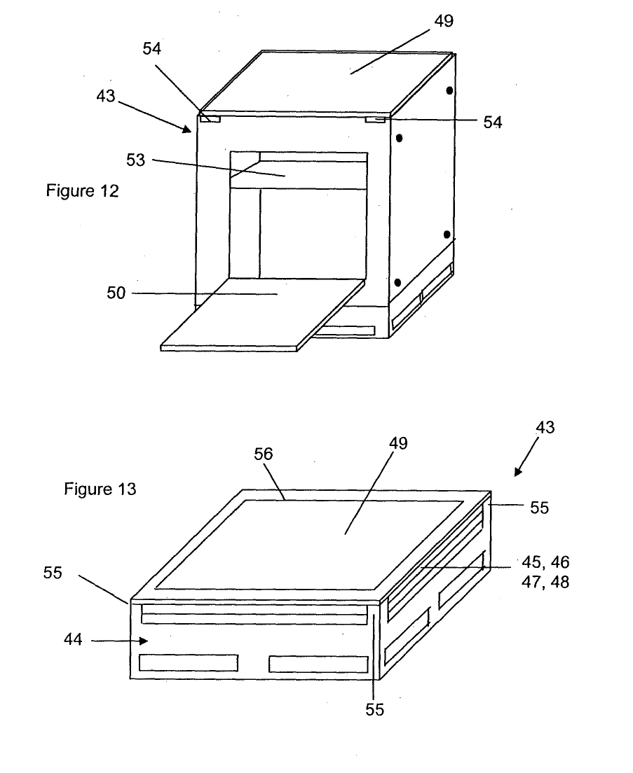

FIG. 12 is a view of the third embodiment with an access door open;

FIG. 13 is a view of the third embodiment in the collapsed state;

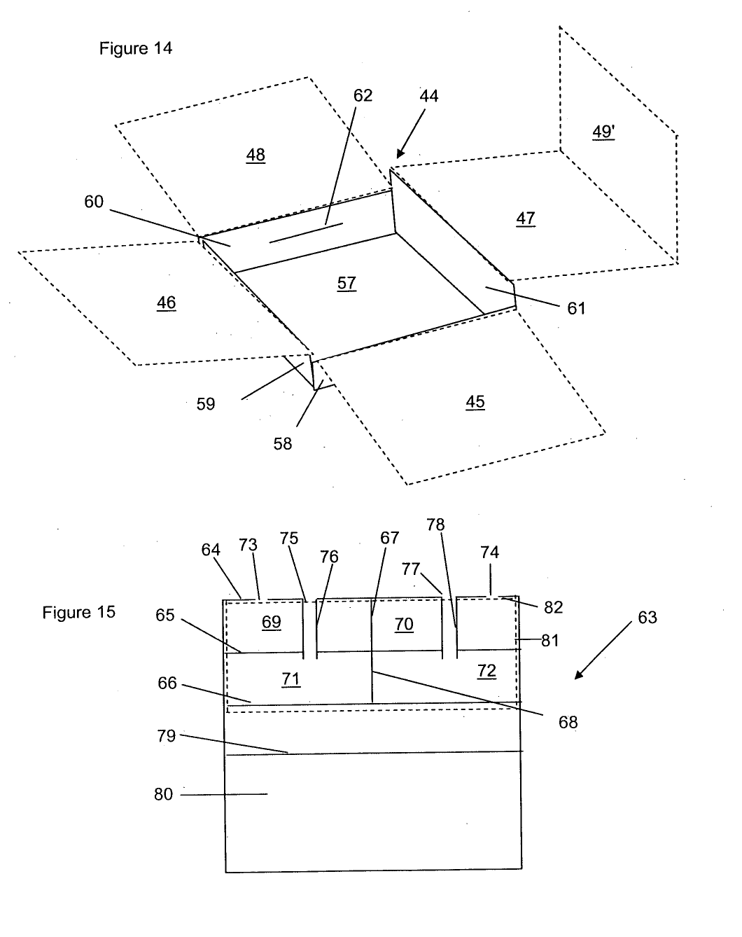

FIG. 14 is a diagram showing how the walls in the third embodiment are attached to the base; and

FIG. 15 is a diagram showing how a container can be arranged to handle batteries in specific compartments

Referring now to the drawings, in FIG. 1 there is shown a collapsible container 1 for waste electrical or electronic equipment. The container comprises a side panel 2, a front panel 3 which serves as a door, a rear panel 4 and another side panel 5. A base shell portion 6 is provided, and this has slots 7 in its front, rear and both sides for receiving the tines of a fork lift truck, allowing for access by the fork lift truck to all four sides container. Effectively, the base shell portion has a double bottom, so as to form the base 8 of the interior of the container (FIG. 2) which has a peripheral wall 9, and to form a base resting on the ground which has the slots 7. The container base could also be provided with wheels to allow movement without the use of a fork lift truck, in a manner analogous to the embodiment of FIG. 10. A top shell portion 10 is provided, having a portion 11 forming the top of the container, and a peripheral wall 12. Latching mechanisms 13 and 14 are provided on the top and base shell portions respectively, and these interlock with regions 15 and 16 of the front panel 3.

The side panels, front panel and rear panel are connected to the top and base shell portions in a manner that enables the container to be collapsed, for example being detachable from the shell portions. The front panel 3 is pivotally attached to the top and base shell portions so that it can open as shown in FIG. 2, to obtain access to the interior of the container. The rear panel 4 could also be constructed in the same manner and also be capable of opening as a door, there then being corresponding latching portions for the rear panel. If desired, one or both side panels could also be constructed in a similar manner to act as a door.

As shown in FIG. 2, a tray 17 is mounted in a top part of the container, being attached to the interior of side panels 2 and 5 in such a manner that it can be slid into and out of the container. The method of attachment is shown in more detail in FIG. 3. The tray 17 carries an array 24 of spaced resilient protrusions described in more detail below. Side panel 5 is provided with vertically spaced horizontally extending extensions 18 to support the tray 17, and corresponding extensions are also provided on the interior of side panel 5. FIG. 3 also shows upper lugs 19 which are used to secure the side panel 2 to the upper shell portion 10, and lower lugs 20 which are used to secure the side panel 2 to the lower shell portion 6, interlocking with the peripheral walls 12 and 9 respectively. The other side panel 2 is attached to the upper and lower shell portions in the same manner.

FIG. 4 shows the front panel 3, which has an upper pivot pin 21 which engages in a mounting on the upper shell portion 10, and a lower pivot pin 22 which engages in a mounting on the lower shell portion 6, so that the panel can be swung between its closed and open positions.

FIG. 5 shows the container in the collapsed state. The front, rear and side panels have been detached from the base and top shell portions 6, 10, and the two shell portions placed together with the panels in the space defined within the pair of shell portions. Latch 13 and a corresponding latch at the rear of the shell portions are used to hold the shell portions together. A series of protrusions 23 are provided in the top surface 11 of top shell portion 10, and a corresponding series of indentations (not shown) are provided in the bottom surface of the base shell portion 6. For storage of collapsed containers or for transportation to a site for use, a number of the containers can be stacked on top of each other. The optional protrusions/indentations will cooperate to resist lateral slippage between stacked containers.

FIG. 6 is a diagrammatic view of the tray 17 which has the array 24 of resilient protrusions 25 which are shown in more detail in FIGS. 7 and 8. The protrusions 25 are arranged in a matrix of regular rows and columns, and in this embodiment are truncated cones. They may be made of rubber or a synthetic resilient material, preferably that is resistant to attack by materials that may leak from broken products. Items such as lights, mobile telephones and so forth may be placed on the tray and gripped by the protrusions 25. The arrows on FIG. 7 show possible orientations for items such as a fluorescent tubes on the tray. A light bulb can be positioned with its bulbous part in the space defined by four protrusions 25, indicated by a dashed circle on FIG. 7.

The base of the tray may be provided with an absorbent layer to trap any liquids that escape from the items.

FIG. 9 shows an alternative type of protrusion 26 comprising an enlarged base 27, a stem 28 and an enlarged top 29 of smaller diameter than the base 27.

FIG. 10 is a front perspective view of an alternative embodiment of collapsible container 30. This has side panels 31 and 32, a front panel 33 which serves as a door and has a latch 34, a rear panel 35, a top shell portion 36 and a bottom shell portion 37. The bottom shell portion 37 is provided with slots 38 for the tines of a fork lift truck, and also with wheels 39 at each corner so that the erect container can be moved around.

In this embodiment, the top of the main part of the container is provided with a partition 40, on which is supported a removable tray 41 carrying protrusions and in a form corresponding to that of tray 17 described with respect to the previous embodiment. The top shell portion can pivoted upwardly with respect to rear panel 35, as shown, to gain access to the tray 41. In the closed condition the top shell portion is held closed by a latch 42. In this arrangement the items in the tray are isolated from the remainder of the container.

In the collapsed state of this embodiment of container, the four panels, the partition and the tray are contained in the space define by the top and base shell portions when they are connected together.

FIG. 11 is a front perspective view of another embodiment of the invention. In this arrangement the container 43 includes is a base member 44, a front panel 45, side panels 46 and 47, a rear panel 48, and a lid 49 which is pivotally attached to the rear panel and is shown in the open condition. The front panel is provided with an access door 50 which is shown closed and is provided with an internal latching mechanism. The base member is provided with slots 51 for access by the times of a fork lift truck. The front, rear and side panels are hinged to the base member as will be described in more detail later. In the erect condition the panels are secured to each other by fasteners 52 which can, for example, be rotated using a tool if necessary, to move portions into latching engagement with adjacent side panels.

Within the container is a tray 53 which may be as described earlier, with protrusions to hold lights and other small items in place, and which in this Figure is shown as being accessible through the top of the container.

FIG. 12 shows the container of FIG. 11 with the lid 49 closed and held in place by latches 54, and with the access door 50 open to allow access to the interior of the container, including the tray 53.

FIG. 13 shows the container 43 in the collapsed state. The side, front and rear panels 45, 46, 47 and 48 have been disconnected from each other and folded flat onto the base member 44, overlying each other. The lid 49 has been attached to four corner portions 55 of the base member, for example by inter-engaging male and female portions, and may also be secured in place by additional clips to one of the panels, this improving security f the collapsed container is stored vertically rather than in the state shown. The base member has a false bottom above the slots for the fork lift truck, and there is a space. between this and the folded panels in which the tray 53 is stored. The lid 49 is shown with a peripheral ridge 56 which engages with corresponding portions in the base of another container, when the containers are stacked.

Although in this embodiment the container is shown without wheels, the base may have mountings to enable optional wheels to be added.

Although each on the panels 45, 46, 47 and 48 is hinged to the base member 44, and the lid is hinged to the rear panel 48, the panels can all be detached from one another. This means that if a panel is damaged, it may be replaced by a spare panel. Effectively, the container is modular.

FIG. 14 is a diagram showing how the panels 45, 46, 47 and 48 are attached to the base member 44. For simplicity, only the upper part of the base member is shown from the interior false base 57 upwards. Below this there will be the remainder of the base member, with the slots for a fork lift truck. In this simple construction as illustrated, there are four side wall portions of the base member, 58, 59, 60 and 61. Side wall portion 58 is the lowest and front panel 45 is hinged to this adjacent its upper edge. Side wall portion 59 is the next highest and side panel 46 is hinged to this adjacent its upper edge. Side wall portion 60 is the next highest and rear panel 48 is hinged to this adjacent its upper edge. Finally, side wall portion 61 is the highest and side panel 47 is hinged to this adjacent its upper edge. The arrangement is such that the front panel is first folded in, then the side panel 46, then the rear panel 48 is folded in over those two panels, and finally side wall 47 is folded over the three panels. The arrangement is such that the top of side wall 47 is below the upper extent of the corner portions 55, so that the lid can be attached.

In a preferred embodiment of this arrangement, the lid 49 remains attached to the rear panel 48 and thus folds over the rear panel when it is folded in. For the lid to serve as a lid for the container in the collapsed condition, the side wall portion 60 should then the highest of the four side wall portions. It is not essential for the lid to be hinged to the rear panel and it could be hinged to another panel, although preferably access should still be possible through the lid when standing at the front of the container. Thus, in FIG. 14 there is shown a modified arrangement in which lid 49′ is hinged to side panel 47, and will be at the top of the stack of panels when they are folded in.

In any event, there is preferably means to lock the lid in position on top of the other panels when the container is in the collapsed state.

As shown in FIG. 14, the rear side wall portion 60 of the base member 44 is provided with a ridge 62 on which front panel 45 rests when folded in. There is then space between front panel 45 and the false base 57 which can accommodate one or more of the trays used within the container.

A further embodiment of the container is specifically adapted to receive batteries, of the type used typical household products such as torches, portable radios, MP3 players and so forth. There may for example be four compartments to handle four commonly used sizes, such as AAA, AA, C and PP3. However, as many sizes as necessary can be coped with, the number of compartments can be varied and sizes might be combined, for example so that AAA and AA are kept together, and other compartments handle sizes C, D and PP3 respectively. There could be a separate compartment for watch type batteries also. To provide the compartments the interior of the container is preferably divided both horizontally and vertically, and in a preferred embodiment by a shelf and by one or more dividers both above and below the shelf. A divider could for example run diagonally from one corner of the container to the other. The container could be exclusively for handling batteries in this manner, or could also handle other waste equipment beneath a second shelf below the batteries, and/or could also include a try for lights and other small items as discussed above. Preferably access to the battery compartments is through the lid of the container, which could have appropriately sized (and marked) apertures for the battery sizes. Apertures for compartments above the shelf could be directly through the lid, and apertures for compartments below the shelf could be via tubes passing through the compartments above and the shelf. There could be a series of shelves defining three or more layers of compartments, with tubes passing through multiple shelves to the compartment concerned.

With the exception of adaptation to incorporate the battery compartments, the container may otherwise be as described in respect of any of the other embodiments.

FIG. 15 is a diagrammatic cross section through a container showing how battery compartments and other container features could be provided. The container 63 has a lid 64 and interior shelves 65 and 66 for use in defining battery compartments a divider 67 above shelf 65 and a divider 68 below shelf 65 forms four battery compartments 69, 70, 71 and 72. A suitable sized aperture 73 in lid 64 provides access to compartment 69 and another aperture 74 in the lid provides access to compartment 70. Aperture 75 in lid 64 communicates with a tube 76 which passes through compartment 69 and shelf 65 into compartment 71. Aperture 77 in lid 64 communicates with a tube 78 which passes through compartment 70 and shelf 65 into compartment 72. A tray 79 is provided beneath the battery compartments, which has protrusions as described above and is for lights or other small items and may be constructed and mounted as described earlier. A space 80 beneath the tray is used to contain larger items of waste equipment. Access to the tray and the space 80 will be through an opening provided as described earlier, for example by pivoting an entire panel or a door therein. Access to the battery compartments for removing the batteries may be through such an opening and/or by opening/removing the lid of the container. The shelves and dividers may be parts of one or more removable modules, provided with side walls within the main container, so that they can be removed intact with the batteries inside. Dotted lines 81 indicate how such a removable module can be provided. The lid 64 can be opened and the entire module taken out, for example using suitable handles. The module could include its own lid beneath the lid 64 of the container, with the apertures and tubes passing through this also. Dotted line 82 indicate such a lid.

There are thus provided embodiments of a versatile container for waste electrical and/or electronic equipment, which is adapted to handle lights and other items in an effective manner and which can be collapsed and erected. In the preferred embodiments of the invention the container has solid walls and in the erected condition presents an effective barrier to small components, broken glass and so forth escaping from the container. Whilst steps could be taken to provide effective sealing of the container to prevent escape—or entry—of liquids, this is generally considered unnecessary, particularly if there is absorbent material within the container to trap such liquids.

Embodiments of the invention provide a collapsible container for the storage and transport of waste electrical and/or electronic equipment has at least one tray provided with an array of upwardly projecting resilient locating portions. The tray receives relatively small waste equipment such as electric lamps, mobile telephones or the like in a number of different orientations in which the items will occupy spaces between the locating portions and will be gripped by the locating portions. The container may be collapsible and comprise a top, a base member, two side walls, a back wall and a front wall. In an erected state of the container the two side walls, the back wall and the front wall are connected to the top and the base member. An access opening is provided by all or part of the front wall and preferably access is also, possible via the top. In the collapsed state of the container the top and the base member cooperate, for example being in contact and interlocked together, so as to define a storage space in which are located the walls of the container and the tray. Compartments specifically adapted to receive electric batteries may also be provided.

1. A container for the storage and transport of waste electrical and/or electronic equipment having therein at least one horizontally disposed tray provided with an array of upwardly projecting resilient locating portions, adapted to receive a plurality of waste electrical and/or electrical items in a plurality of different orientations in which the items will occupy spaces between the locating portions and will be gripped by the locating portions.

2. A container as claimed in claim 1, wherein the array of locating portions is such that a fluorescent light tube can be located and gripped between two adjacent lines of locating portions.

3. A container as claimed in claim 1 or 2, wherein the array of locating portions is such that a bulbous part of a light bulb or an enlarged end of a spot light bulb can be located and gripped in the space between four adjacent locating portions.

4. A container as claimed in claim 1, 2 or 3, wherein the array of locating portions is such that a mobile telephone can be located and gripped between two adjacent lines of locating portions.

5. A container as claimed in any preceding claim, wherein the locating portions are arranged in a matrix of rows and columns.

6. A container as claimed in any preceding claim, wherein the tray is provided with a liquid absorbent base.

7. A container as claimed in any preceding claim, wherein the tray is removable.

8. A container as claimed in any preceding claim, wherein the tray is in a portion of the container separated from the remainder of the container by a partition.

9. A container as claimed in any preceding claim, adapted to hold a plurality of vertically spaced trays.

10. A container as claimed in any preceding claim, comprising a front wall, a rear wall, two side walls, a top member and a base member, and at least a portion one of the walls serving as a door to provide access to the interior of the container.

11. A container as claimed in claim 10, wherein the top member is openable to provide access to the tray.

12. A container as claimed in claim 10 or 11, wherein the base member is provided with slots for receiving the tines of a fork lift truck.

13. A container as claimed in claim 10, 11 or 12, wherein the base member is provided with wheels.

14. A container as claimed in any of claims 10 to 13, which is collapsible.

15. A container as claimed in claim 14, wherein when the container is collapsed the top member and the base member cooperate to define an interior space which contains the front wall, the rear wall and the two side walls.

16. A container as claimed in claim 15, wherein the base member defines a space to hold the walls and the top member serves as a lid which is attached to the base member when the container is in the collapsed condition.

17. A container as claimed in claim 15 or 16, wherein the base member defines an interior portion below where the walls will be located, to hold the tray when the container is in the collapsed condition.

18. A container as claimed in any of claims 14 to 17, wherein the base member is be attached to the base of the front wall by a first hinge along a front part of the base member, to the base of one side wall by a second hinge along one side part of the base member, to the base of the rear wall by a third hinge along a rear part of the base member, and to the base of the other side wall by a fourth hinge along the other side part of the base member, with the vertical positions of the first, second, third and fourth hinges being displaced from each other, such that the front, rear and two side walls may be folded inwardly to overlie each other in the collapsed state of the container.

19. A container as claimed in claim 18, wherein the top member can be connected to upwardly directed portions of the base member, overlying the folded walls of the container, when the container is in the collapsed state.

20. A container as claimed in any of claims 14 to 19, wherein the top member is connected by a hinge to one of the front wall, rear wall or one of the side walls.

21. A collapsible container for the storage and transport of waste electrical and/or electronic equipment, which comprises a top member defining a top of the container, a base member defining a base of the container, two side walls, a rear wall and a front wall; wherein (a) in an erected state of the container the two side walls, the rear wall and the front wall are connected to the top member and the base member to form a substantially rigid structure, with at least part of the front wall being movable pivotally between a closed position preventing access to the interior of the container, and an open position in which there is access to the interior of the container; and (b) in a collapsed state of the container the top member and the base member cooperate so as to define a storage space in which are located the two side walls, the rear wall and the front wall.

22. A container as claimed in claim 21, wherein the base member defines a space to hold the walls and the top member serves as a lid which is attached to the base member when the container is in the collapsed condition.

23. A container as claimed in claim 21 or 22, wherein the base member is be attached to the base of the front wall by a first hinge along a front part of the base member, to the base of one side wall by a second hinge along one side part of the base member, to the base of the rear wall by a third hinge along a rear part of the base member, and to the base of the other side wall by a fourth hinge along the other side part of the base member, with the vertical positions of the first, second, third and fourth hinges being displaced from each other, such that the front, rear and two side walls may be folded inwardly to overlie each other in the collapsed state of the container.

24. A container as claimed in claim 23, wherein the top member can be connected to upwardly directed portions of the base member, overlying the folded walls of the container, when the container is in the collapsed state.

25. A container as claimed in any of claims 21 to 24, wherein the top member is connected by a hinge to one of the front wall, rear wall or one of the side walls.

26. A collapsible container as claimed in any of claims 21 to 25, including at least one horizontally disposed tray provided with an array of upwardly projecting resilient locating portions, adapted to receive a plurality of lights in a plurality of different orientations in which the lights will occupy spaces between the locating portions and will be gripped by the locating portions.

27. A method of storing waste electrical and/or electronic equipment in a container as claimed in any of claims 1 to 20 or claim 26, wherein at least one waste item of electrical or electronic waste is located in the tray by means of the locating portions, and at least one other item of waste electrical and/or electronic equipment is located in another part of the container.

28. A method as claimed in claim 27, wherein said at least one item is a lamp.

29. A container as claimed in any of claims 1 to 26, including a plurality of compartments to contain electrical batteries, provided in a module which is removable from the container.

30. A container as claimed in any of claims 1 to 26, the container further being provided with a horizontal shelf and one or more vertical dividers which cooperate to define a plurality of battery compartments, there being a plurality of apertures in the top of the container which provide access to respective ones of the battery compartments, and the or each battery compartment below the shelf communicating with its corresponding aperture in the top of the container by means of a tube which passes through a battery compartment above the shelf and through the shelf.

31. A container for waste electrical or electronic products, having a base, side walls, a top and a lid, the container further being provided with a horizontal shelf and one or more vertical dividers which cooperate to define a plurality of battery compartments within the container, there being a plurality of apertures in the lid of the container which provide access to respective ones of the battery compartments, and the or each battery compartment below the shelf communicating with its corresponding aperture in the lid of the container by means of a tube which passes through a battery compartment above the shelf and through the shelf.

32. A container as claimed in claim 31, incorporating a space below the battery compartments for other items of electrical or electronic waste.

33. A container as claimed in claim 31 or 32, wherein the battery compartments are defined within a removable module having side walls to retain the batteries.
